(19) United States
(12) Patent Application Publication
(10) Pub. No.: US 2020/0109781 A1
(43) Pub. Date: Apr. 9, 2020

(54) DETONATION RESISTANT PISTON

(71) Applicant: Federal-Mogul Motorparts LLC, Southfield, MI (US)

(72) Inventors: Anthony Bartolomei, Evanston, IL (US); Hoover Oliver, La Grange, IL (US); Michael Sadowski, Elmhurst, IL (US)

(21) Appl. No.: 16/595,977

(22) Filed: Oct. 8, 2019

Related U.S. Application Data
(60) Provisional application No. 62/742,606, filed on Oct. 8, 2018.

(51) Int. Cl. F16J 1/09; F16J 1/18

(52) U.S. Cl. CPC F16J 1/09; F16J 1/18

(57) ABSTRACT

The piston includes a pair of pin bores that are aligned with one another along a pin bore axis. The piston further includes a crown that has a top combustion surface with an outer rim and a ring belt that depends from the outer rim. The ring belt includes a top land and a first ring groove for receiving a piston ring. At least one recess is formed into the top land and extends from the top combustion surface less than a full distance from the top combustion surface to the first ring groove.

### CROSS-REFERENCE TO RELATED APPLICATION

This U.S. Patent Application claims the benefit of U.S. Provisional Patent Application Ser. No. 62/742,606, filed Oct. 8, 2018 entitled “DETONATION RESISTANT PISTON,” the entire disclosure of the application being considered part of the disclosure of this application and hereby incorporated by reference.

### BACKGROUND OF THE INVENTION

### 1. Field of the Invention

The present invention is related generally to pistons for internal combustion engines.

### 2. Related Art

In an effort to reduce improve performance in internal combustion engines, piston manufacturers are increasingly turning towards aluminum and aluminum alloys to reduce mass. One drawback to the use of aluminum though is that it has a lower melting temperature and a lower strength as compared to steel, and thus, an aluminum piston is more susceptible to damage if it encounters extreme temperatures or loads.

Another trend in the internal combustion engine industry is a movement towards alternative fuels, such as landfill gas, which is primarily comprised of methane. One drawback to the use of landfill gas is that it is generally very impure and varies greatly in composition. Thus, when landfill gas is used, it can result in uncontrolled combustion and detonation (also known as knock), which creates a localized and temporary detonation zone within the combustion chamber. Within that detonation zone, the combustion chamber experiences extremely high temperatures and pressures. If the material of an aluminum piston is located within this detonation zone, the aluminum material of the piston can erode, deform or melt. In most cases, the detonation zone is located in an area adjacent an outer edge of the piston when the piston is in or near the top dead center position between the compression and power strokes, and thus, this area of the piston is most susceptible to damage from detonation.

One known approach to preventing the damage that can result from uncontrolled detonation is to bring the combustion under control. However, this approach typically requires costly modifications to the engine, such as to the spark and valve timing.

### SUMMARY OF THE INVENTION

One aspect of the present invention is related to a piston for an internal combustion engine. The piston includes a pair of pin bores that are aligned with one another along a pin bore axis. The piston further includes a crown that has a top combustion surface with an outer rim and a ring belt that depends from the outer rim. The ring belt includes a top land and a first ring groove for receiving a piston ring. At least one recess is formed into the top land and extends from the top combustion surface less than a full distance from the top combustion surface to the first ring groove.

The piston has been found to be especially resistant to collateral damage from uncontrolled detonation of a fuel and air mixture within a combustion chamber above the piston, and this increased resistance to damage is achieved with little additional cost and without any changes being necessary in the engine itself.

According to another aspect of the present invention, the at least one recess extends across a point of the top combustion surface which is located at ninety degrees relative to the pin bore axis.

According to yet another aspect of the present invention, the at least one recess is a pair of recesses.

According to still another aspect of the present invention, the pair of recesses are diametrically opposite of one another.

According to a further aspect of the present invention, the piston is symmetrical about a plane which extends perpendicularly to the pin bore axis.

According to yet a further aspect of the present invention, the top combustion surface has a combustion bowl.

According to still a further aspect of the present invention, a nickel coating covers a portion of the top combustion surface.

According to another aspect of the present invention, the nickel covering covers the at least one recess.

Another aspect of the present invention is related to a power cylinder assembly for an internal combustion engine. The power cylinder assembly includes a cylinder liner which surrounds a cylinder bore. A piston is disposed in the cylinder bore and is able to reciprocate along a central axis within the cylinder bore. The piston has a crown and a pair of pin bores which are aligned with one another along a pin bore axis. The piston also has a top combustion surface with an outer rim and a ring belt depending from the outer rim. The ring belt includes a top land and a first ring groove for receiving a piston ring. At least one recess is formed into the top land and extends from the top combustion surface less than a full distance from the top combustion surface to the first ring groove.

According to another aspect of the present invention, the at least one recess extends across a point of the top combustion surface which is located at ninety degrees relative to the pin bore axis.

According to yet another aspect of the present invention, the at least one recess is a pair of recesses.

According to still another aspect of the present invention, the pair of recesses are diametrically opposite of one another.

According to a further aspect of the present invention, the piston is symmetrical about a plane which extends perpendicularly to the pin bore axis.

According to yet a further aspect of the present invention, the top combustion surface has a combustion bowl.

According to still a further aspect of the present invention, a nickel coating covers a portion of the top combustion surface.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective view of an exemplary embodiment of a piston which is constructed according to one aspect of the present invention;

FIG. 2 is a front elevation view of the piston of FIG. 1;

FIG. 3 is a side elevation view of the piston of FIG. 1;

FIG. 4 is a top elevation view of the piston of FIG. 1;

FIG. 5 is a bottom elevation view of the piston of FIG. 1;

FIG. 6 is a perspective view showing the piston of FIG. 1 as installed in an internal combustion engine;

FIG. 7 is a partially cross-sectional view showing the piston of FIG. 1 as installed in an engine during use;

FIG. 8 is another partially cross-sectional view showing the piston of FIG. 1 as installed in an engine during use; and

FIG. 9 is a partially cross-sectional view showing a second embodiment of the piston as installed in an engine during use.

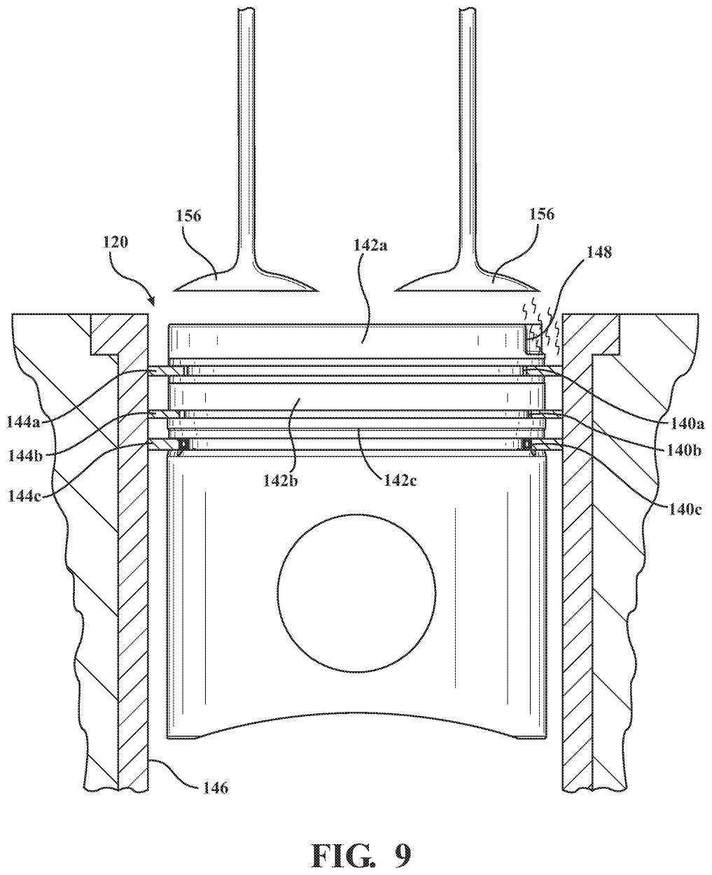

### DESCRIPTION OF THE ENABLING EMBODIMENT

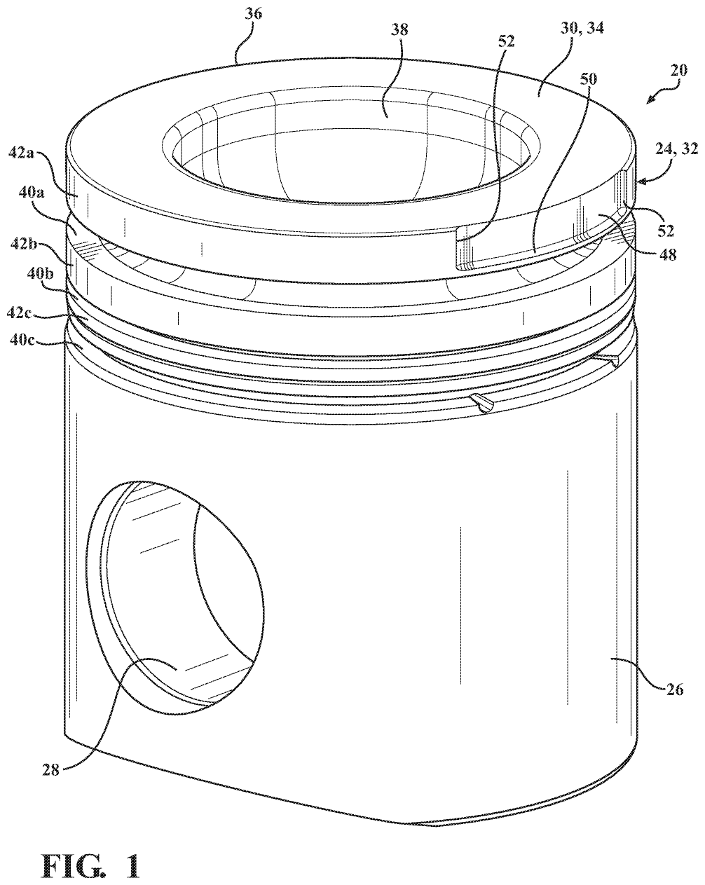

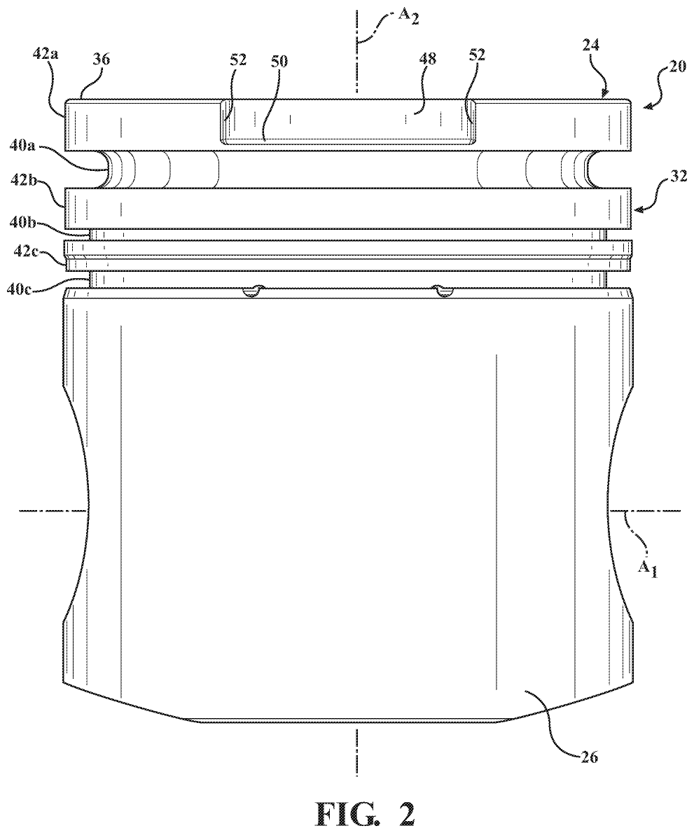

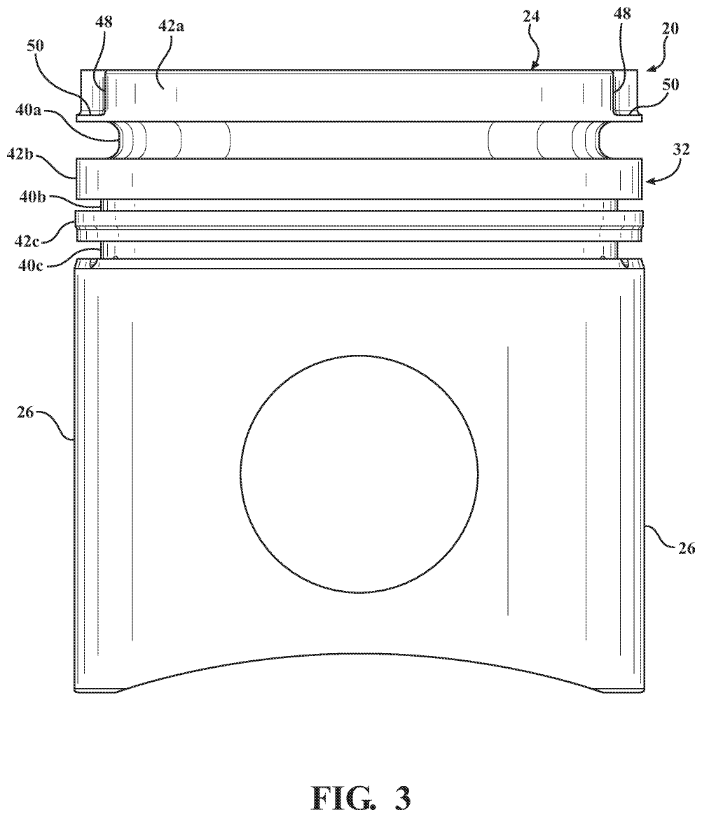

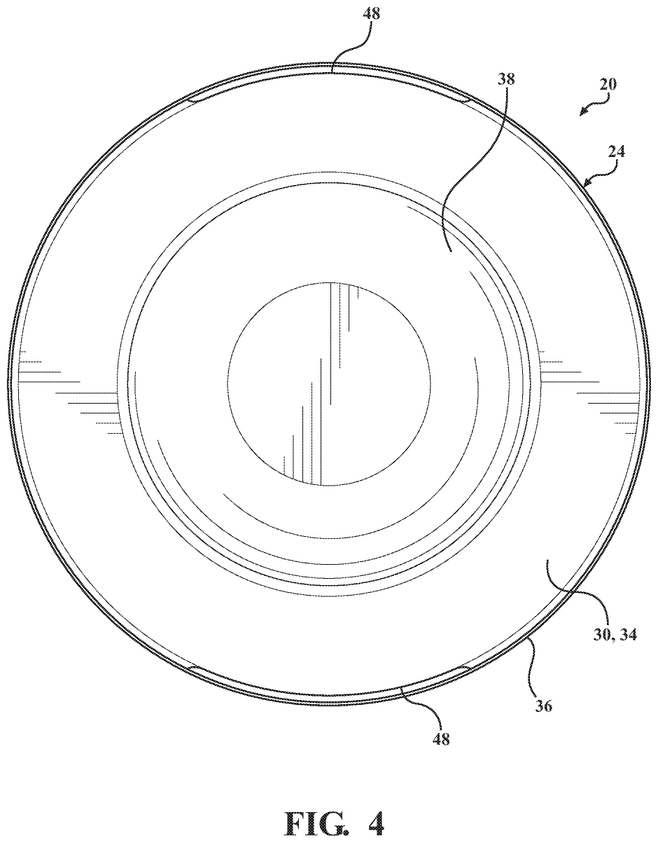

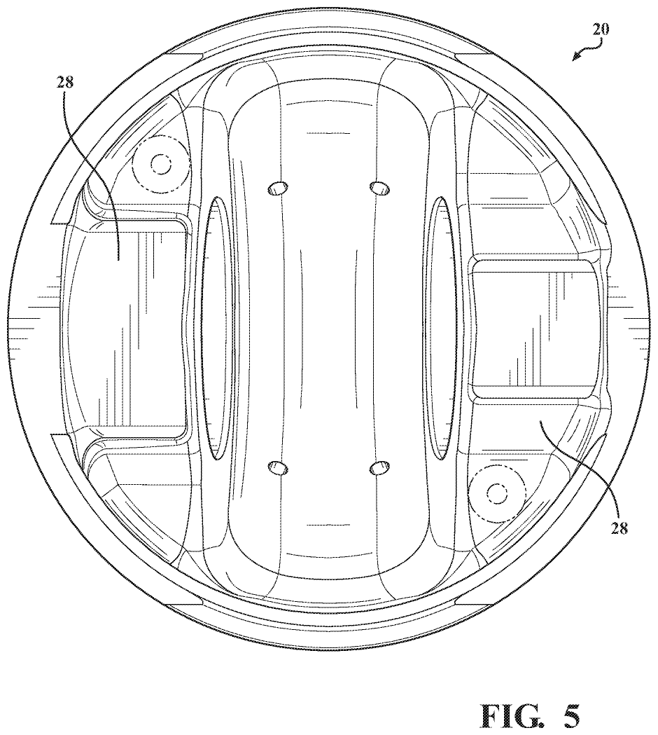

Referring to the Figures, wherein like numerals indicate corresponding parts throughout the several views, one aspect of the present invention is related to an improved piston 20 for an internal combustion engine 22. As discussed in further detail below, the piston 20 has an increased resistance to erosion and melting in the event of uncontrolled detonation (engine knock) within a combustion chamber of the engine 22. The piston 20 of the first exemplary embodiment (shown in FIGS. 1-6) is specifically designed for use in a landfill gas fueled internal combustion engine, such as the Caterpillar G3500®. However, it should be appreciated that the piston 20 could alternately be configured for use in gasoline or diesel fueled internal combustion engines. The piston 20 is preferably made of aluminum or an aluminum alloy and may be shaped through any suitable process or combination of processes including, for example, casting, forging, sintering, machining, etc.

The piston 20 of the first exemplary embodiment is of the monobloc type in that it includes a crown 24, a pair of skirts 26, and a pair of pin bosses 28 that are all integrally monolithic with or fixedly connected with one another. In other words, the piston 20 could be constructed as a single monolithic piece, such as through an additive manufacturing operation, or it could be made of multiple pieces which are separately fabricated and then are subsequently fixedly attached with one another. The pin bosses 28 present pin bores which are aligned with one another along a pin bore axis A₁ configured to receive a gudgeon pin (not shown) which, in turn, connects the piston 20 with a connecting rod (not shown) in the internal combustion engine 22. In alternate embodiments, the skirts could be made as a separate piece from the other elements of the piston in an articulating skirt design.

The crown 24 extends along a central axis A₂ and has an top combustion surface 30 and a ring belt 32 which extends axially downwardly away therefrom. The top combustion surface 30 has a planar and annularly shaped outer portion 34 which defines an outer rim 36 or edge. The top combustion surface 30 also has a combustion bowl 38 which is spaced radially inwardly from the outer rim 36 and extends axially downwardly towards the pin bosses 28. The combustion bowl 38 of the exemplary embodiment has a so-called “Mexican Hat” design, but alternate shapes could be employed depending on the configuration of the internal combustion engine 22 or, as commonly is the case of pistons for gasoline fueled engines, no combustion bowl may be present at all.

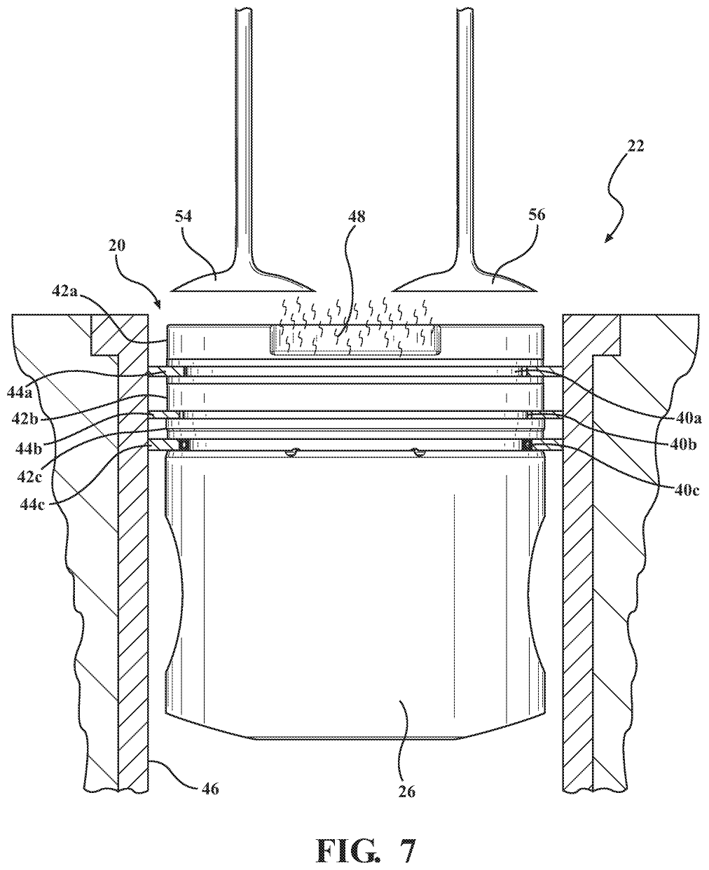

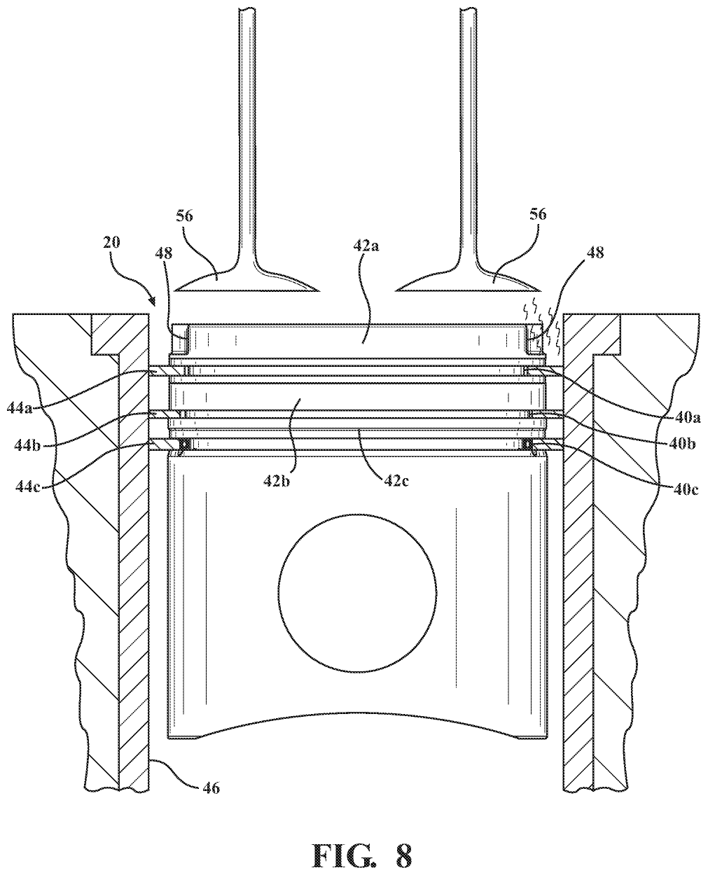

The ring belt 32 includes a plurality of ring grooves 40a, 40b, 40c which are spaced axially from one another by a plurality of lands 42a, 42b, 42c. More specifically, the ring belt 32 includes a top land 42a which extends axially from the top combustion surface 30 to a first ring groove 40a. As shown in FIGS. 7 and 8, a plurality of piston rings 44a, 44b, 44c are received in the ring grooves 40a, 40b, 40c for sealing the piston 20 against a cylinder liner 46. Any suitable combination of compression rings, oil control rings and hybrid rings may be employed.

The top land 42a includes a pair of recesses 48 formed therein to increase the clearance between certain areas of the top land 42a and a cylinder liner 46 in the areas of these recesses 48 without altering the clearance in the other areas of the top land 42a. The recesses 48 are diametrically opposed from one another and are both located at approximately a ninety degree (90°) angle relative to the pin bore axis A₁. Each recess 48 has a bottom 50 which is spaced axially above and extends parallel with the top ring groove 40a. Thus, neither recess 48 extends the full axial distance from the top combustion surface 30 to the top ring groove 40a. Each recess 48 also has a pair of sides 52 which extend parallel to the central axis A₂. In the first exemplary embodiment, each recess 48 also has a generally constant radial depth of approximately 1.5 mm along its 75 mm circumferential length from one side 52 to the other. These dimensions have been found to be particularly effective at reducing piston damage from knock in at least one type of landfill gas fueled internal combustion engine 22. In other applications, these dimensions could vary.

Because the crown 24 is provided with two diametrically opposed recesses 48, the piston 20 of the first exemplary embodiment is symmetrical about a plane which extends perpendicularly to the pin bore axis A₁. The symmetrical construction eliminates the need for side specific requirements while installing the piston 20 into a cylinder bore, i.e., a mechanic can install the piston 20 into the cylinder bore in either direction. The piston 20 is preferably cast or forged to its near final shape, and then the recesses 48 are machined into the top land 42a during a finishing operation after casting or forging process is completed.

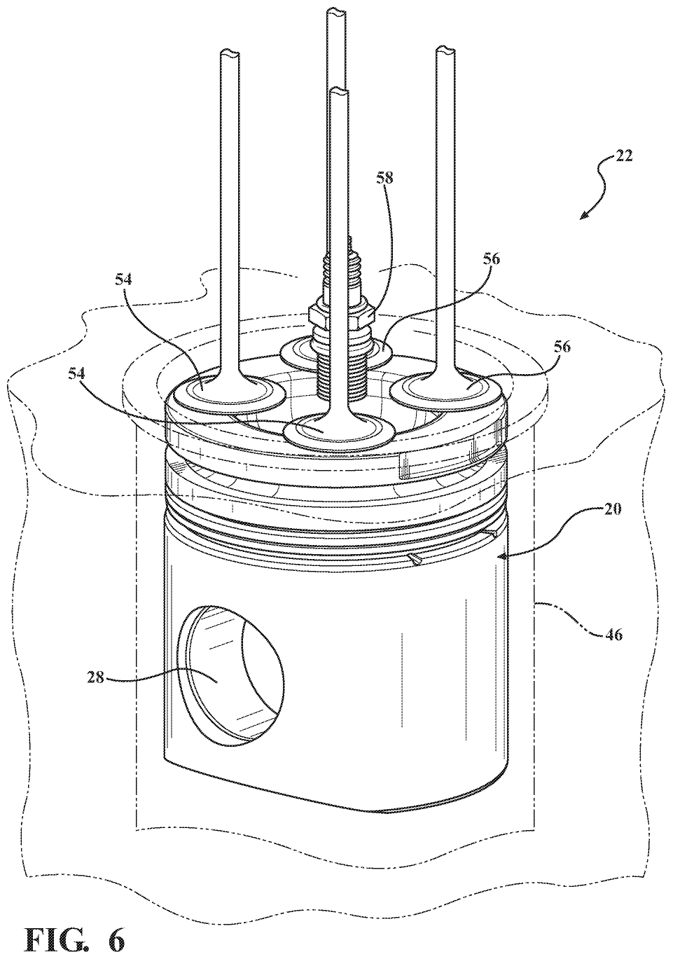

With reference to FIGS. 6-8, the piston 20 of the first exemplary embodiment is shown as installed in a heavy duty internal combustion engine 22 which is configured to burn landfill gas which has varying impurity levels. The engine 22 includes a cylinder liner 46 which surrounds a cylinder bore, a pair of intake valves 54, a pair of exhaust valves 56, and a spark plug 58. One of the recesses 48 is located adjacent with and between one of the intake valves 54 and one of the exhaust valves 56. The presence of one of the recesses 48 in this area removes material from the area of the piston 20 where knock is most likely to occur in this engine design, i.e., along the cylinder liner 46 in the area between an intake valve 54 and an exhaust valve 56. The material removed is relatively small, and thus, any reduction in engine performance from the absence of material in this area is minimal. This advantage has been found to be particularly beneficial in heavy duty engines which are configured to burn landfill gas that has varying purity levels. For example, FIGS. 7 and 8 show detonation occurring in an area which extends partially into the recesses 48.

In the first exemplary embodiment of the piston 20, a 10-20 μm thick nickel plating is applied to the entire top combustion surface 30 and into both of the recesses 48 to reduce the formulation of deposits and to reduce piston 20 temperatures. This reduction in temperature and formulation of deposits reduces the probability of knock occurring. The nickel plating is preferably applied to the piston 20 via an electroplating operation in order to reduce the magnitude of localized thermal and mechanical stresses in these areas of the crown 24 and also allow the height of the crown 24 to be minimized without compromising the strength of the piston 20. As compared to pistons without a nickel plating, the nickel plating on the piston 20 of the exemplary embodiment also may increase the time between maintenance shutdowns, which are often required to remove deposits from the crowns of other known pistons.

Referring now to FIG. 7, a second embodiment of the piston 120 is generally shown with like numerals, separated by a prefix of “1”, indicated similar parts with the above-described first embodiment. In the second embodiment, the top land 142a only includes a single recess 148, not two diametrically opposed recesses 48 as is the case in the first embodiment described above. Also, the second embodiment is distinguished from the first in that the nickel plating is only applied to the piston 120 in the recess 148 and in the area of the top combustion surface 130 immediately adjacent the recess 148.

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other.

What is claimed is:

1. A piston for an internal combustion engine, comprising:
a pair of pin bores which are aligned with one another along a pin bore axis;
a crown having a top combustion surface with an outer rim and a ring belt depending from said outer rim, said ring belt including a top land and a first ring groove for receiving a piston ring; and
at least one recess formed into said top land and extending from said top combustion surface less than a full distance from said top combustion surface to said first ring groove.

2. The piston as set forth in claim 1 wherein said at least one recess extends across a point of said top combustion surface which is located at ninety degrees relative to said pin bore axis.

3. The piston as set forth in claim 1 wherein said at least one recess is a pair of recesses.

4. The piston as set forth in claim 3 wherein said pair of recesses are diametrically opposite of one another.

5. The piston as set forth in claim 4 wherein said piston is symmetrical about a plane which extends perpendicularly to said pin bore axis.

6. The piston as set forth in claim 1 wherein said top combustion surface has a combustion bowl.

7. The piston as set forth in claim 1 wherein a nickel coating covers a portion of said top combustion surface.

8. The piston as set forth in claim 7 wherein said nickel coating covers said at least one recess.

9. A power cylinder assembly, comprising:
a cylinder liner which surrounds a cylinder bore;
a piston disposed in said cylinder bore and able to reciprocate along a central axis;
said piston having;
a crown and a pair of pin bores which are aligned with one another along a pin bore axis,
a pair of pin bores which are co-axially aligned with one another along a pin bore axis,
a top combustion surface with an outer rim and a ring belt depending from said outer rim,
said ring belt including a top land and a first ring groove for receiving a piston ring, and
at least one recess formed into said top land and extending from said top combustion surface less than a full distance from said top combustion surface to said first ring groove.

10. The power cylinder assembly as set forth in claim 9 wherein said at least one recess extends across a point of said top combustion surface which is located at ninety degrees relative to said pin bore axis.

11. The power cylinder assembly as set forth in claim 9 wherein said at least one recess is a pair of recesses.

12. The power cylinder assembly as set forth in claim 11 wherein said pair of recesses are diametrically opposite of one another.

13. The power cylinder assembly as set forth in claim 12 wherein said piston is symmetrical about a plane which extends perpendicularly to said pin bore axis.

14. The power cylinder assembly as set forth in claim 9 wherein said top combustion surface has a combustion bowl.

15. The power cylinder assembly as set forth in claim 9 wherein a nickel coating covers a portion of said top combustion surface.
